(19) United States
(12) Patent Application Publication
(10) Pub. No.: US 2005/0264849 A1
(43) Pub. Date: Dec. 1, 2005

(54) Printer

(75) Inventor: Takahiro Hagiwara, Chiba-shi (JP)

Correspondence Address: FOLEY AND LARDNER;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 10/855,360

(22) Filed: May 28, 2004

(51) Int. Cl. H04N 1/48; H04N 1/40; H04N 1/405; H04N 1/41

(52) U.S. Cl. 358/2.1; 358/3.24; 358/518; 358/426.04; 358/3.06

(57) ABSTRACT

A main CPU analyzes a PDL that is sent via an interface on the basis of a program that is prestored in a ROM. If the kind of object is specified as a bit map, the main CPU converts the bit map data to an internal data format and counts pixels with respect to each pixel kind. Based on the count result, the main CPU determines an applicable pattern, switches a color conversion unit, switches a spatial filter process unit, switches a compression method process unit, switches a decompression method process unit, and switches a halftone pattern process unit. Further, the main CPU executes color determination for the bit map data, sets a monochromatic print or a color print in accordance with a color determination result, and transfers the resultant data as print data to a printer unit.

### BACKGROUND OF THE INVENTION

1. Field of the Invention

The present invention relates to a printing apparatus, such as a printer or a multi-function peripheral, that executes an image process to effect printing.

2. Description of the Related Art

At present, most of printers have a technique for obtaining an optimal print result by switching a color conversion process, a halftone pattern, etc. in accordance with the kind of a to-be-printed object (text, graphics, bit map). In the case of text, for example, the number of screen lines is increased to enhance resolution and to sharpen edges of a character. In the case of bit map data of, e.g. a photo, the number of screen lines is not increased, but more importance is placed on the tone with a smoothed variation in color.

As regards a black-adding process, in the case of text or graphics, as shown in FIG. 1, a black part, in many cases, is printed with a single black toner. In the case of a bit map, printing with a black toner alone may lead to an unnatural print result, so a mixed-color printing, with a color toner mixed, is performed in many cases.

As is shown in FIG. 2, however, a bit map includes not only photo data (natural image) but also other data that is not always suitable for photo image processing, such as CAD data composed mainly of characters and lines, or scan data composed mainly of a text document.

In a prior-art method, the object kind (text, graphics, bit map) up to a PDL (Page Description Language) level can be discriminated to perform a proper image process. However, it is not possible to further classify bit map data to perform an optimal image process.

In the case of bit map data in which color characters, as shown in FIG. 3, are present on a map of Japan that is drawn with thin lines (gray), the bit map data is processed as a color image. Thus, in usual cases, a gray-line part is printed in black with a toner including both a black toner and a color toner mixed. Consequently, if a misregistration occurs, misaligned colors are printed, as shown in the right part of FIG. 3, and a print result becomes very unsightly.

In a case where a color character is present on a part of black-and-white photo bit map data that is composed mainly of a gray part, the gray part is printed with a color toner. However, if a misregistration occurs, a misregistered part is colored and becomes bluish or reddish.

FIG. 4 illustrates a special example in which a very thin gray part, which is drawn by a pencil or the like, lies on a bit map, and color bit map characters are present. In the case of this bit map data, a correction process for making thin lines dense may emphatically executed in a black-and-white mode. However, since a color image process is executed in this case, such a correction process cannot fully be performed in anticipation of the occurrence of a problem, and an adequate density cannot be obtained.

### BRIEF SUMMARY OF THE INVENTION

The object of an aspect of the present invention is to provide a printing apparatus that is capable of effecting printing by further classifying bit map data and subjecting the bit map data to an optimal image process.

According to an aspect of the present invention, there is provided a printing apparatus that performs color printing, comprising: specifying means for specifying whether print data that is to be printed by the printing apparatus includes bit map data; classifying means for classifying pixels that constitute the bit map data, when the bit map data is specified by the specifying means; count means for counting a number of pixels that are classified by the classifying means; determination means for determining an image process pattern that is to be applied, on the basis of a ratio of a count number of the classified pixels that are counted by the count means; and image process means for processing an image on an area of the bit map data, using the image process pattern that is determined by the determination means.

Additional objects and advantages of an aspect of the invention will be set forth in the description which follows, and in part will be obvious from the description, or may be learned by practice of the invention. The objects and advantages of an aspect of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the embodiments given below, serve to explain the principles of an aspect of the invention.

FIG. 1 is a view for explaining a general color conversion process (prior art);

FIG. 2 is a view for explaining a general bit map process (prior art);

FIG. 3 illustrates an example of a problem in the general bit map process (prior art);

FIG. 4 illustrates an example of a problem in the general bit map process (prior art);

FIG. 5 is a block diagram that schematically shows the structure of a digital multi-function peripheral;

FIG. 6 illustrates an example of a pixel count method;

FIG. 7 shows an example of a pixel count table;

FIG. 8 shows an example of a color determination table;

FIG. 9 shows an example of an image process pattern setting table;

FIG. 10 shows an example of image process combinations;

FIG. 11 is a view for explaining an adjustment mode;

FIG. 12 shows an example of adjustment with the property of a printer driver;

FIG. 13 shows an example of a print original;

FIG. 14 shows an example of a PDL file;

FIG. 15 shows an example of an internal format structure;

FIG. 16 is a flow chart illustrating an image process according to a first embodiment of the invention;

FIG. 17 is a flow chart illustrating the image process according to the first embodiment;

FIG. 18 shows an example of a print original;

FIG. 19 shows an example of a PDL file;

FIG. 20 shows an example of an internal format structure;

FIG. 21 is a flow chart illustrating an image process according to a second embodiment of the invention; and

FIG. 22 is a flow chart illustrating the image process according to the second embodiment.

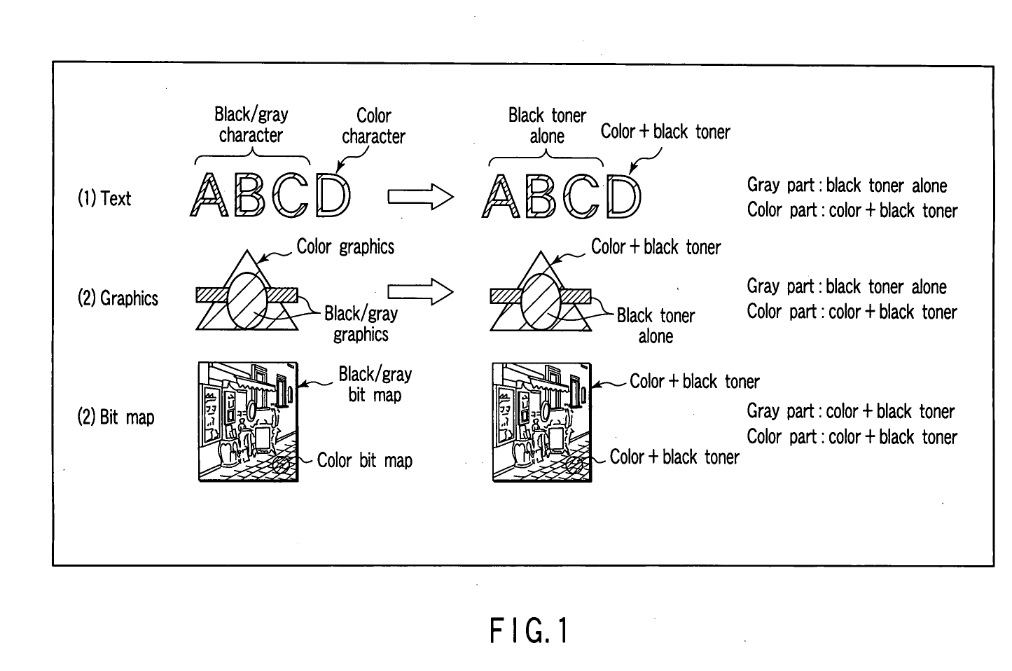

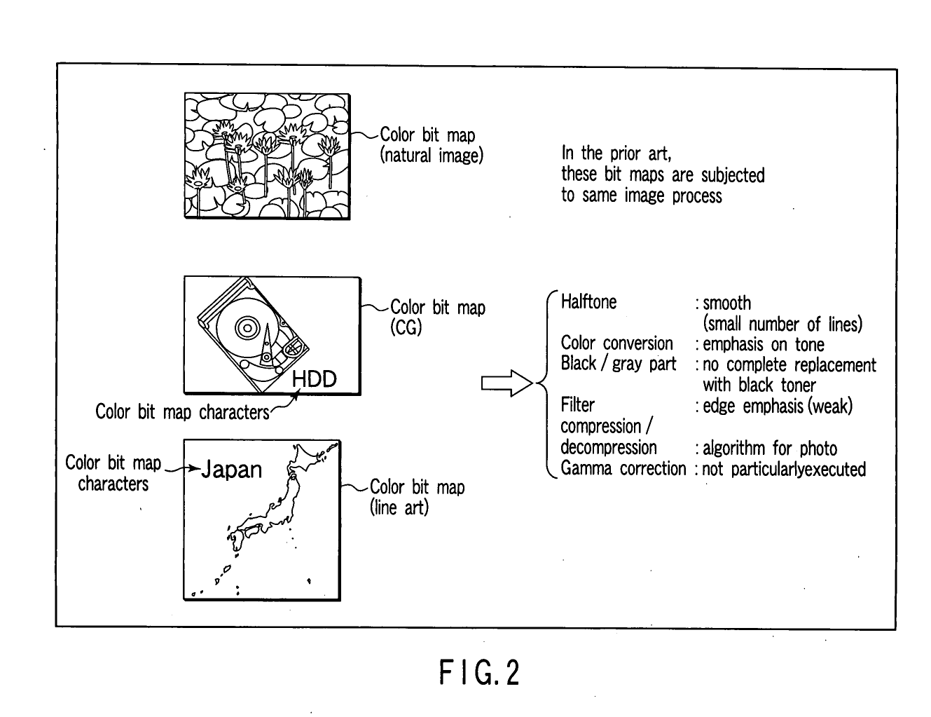

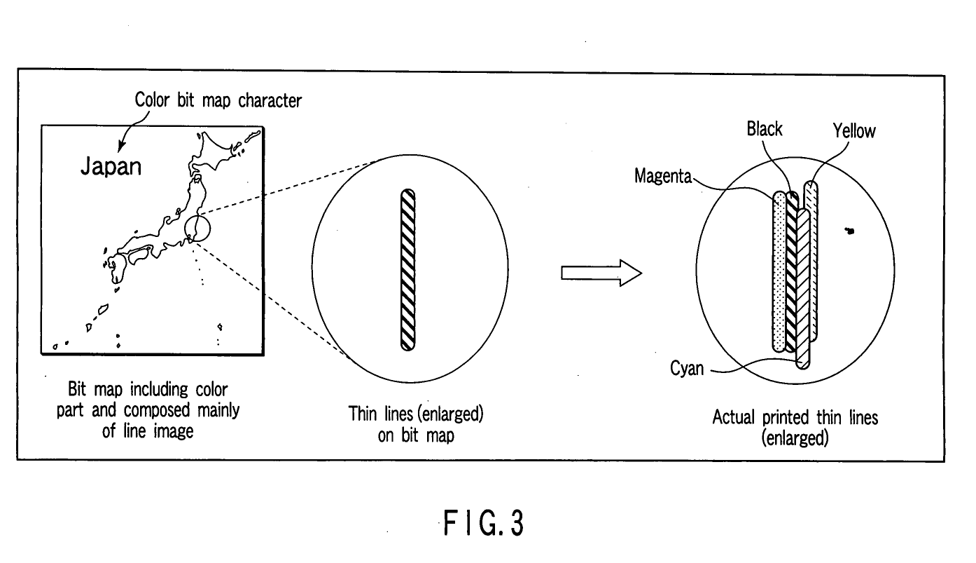

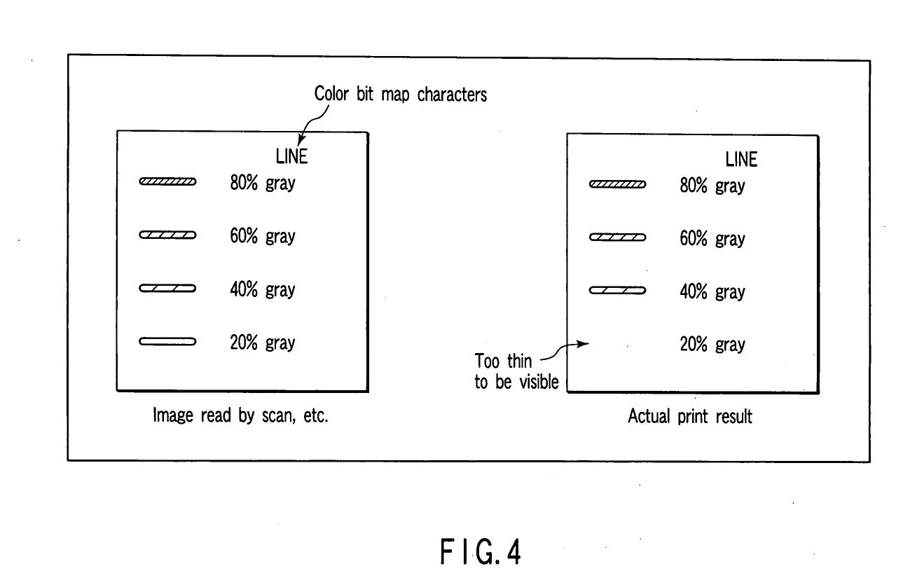

### DETAILED DESCRIPTION OF THE INVENTION

Embodiments of the present invention will now be described with reference to the accompanying drawings.

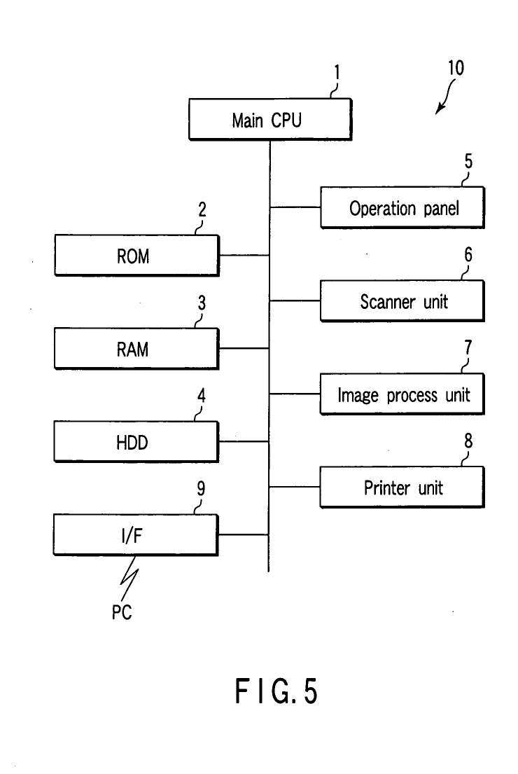

FIG. 5 shows the structure of a digital multi-function peripheral (MFP) 10 according to a printing apparatus of the present invention. The MFP 10 comprises a main CPU 1 for an overall control; a ROM 2 that stores a control program relating to the present invention; a RAM 3 that temporarily stores data; a hard disk drive (HDD) 4 that stores bit map data, etc.; an operation panel 5; a scanner unit 6; an image processing unit 7 that executes an image process as hardware; a printer unit 8; and an interface (I/F) 9 that connects to a personal computer (PC).

In the present invention with the above structure, the kind of bit map data is determined using the kind of pixels that constitute a bit map and the number of pixels, and a proper image process is executed on the basis of selection according to the determination result.

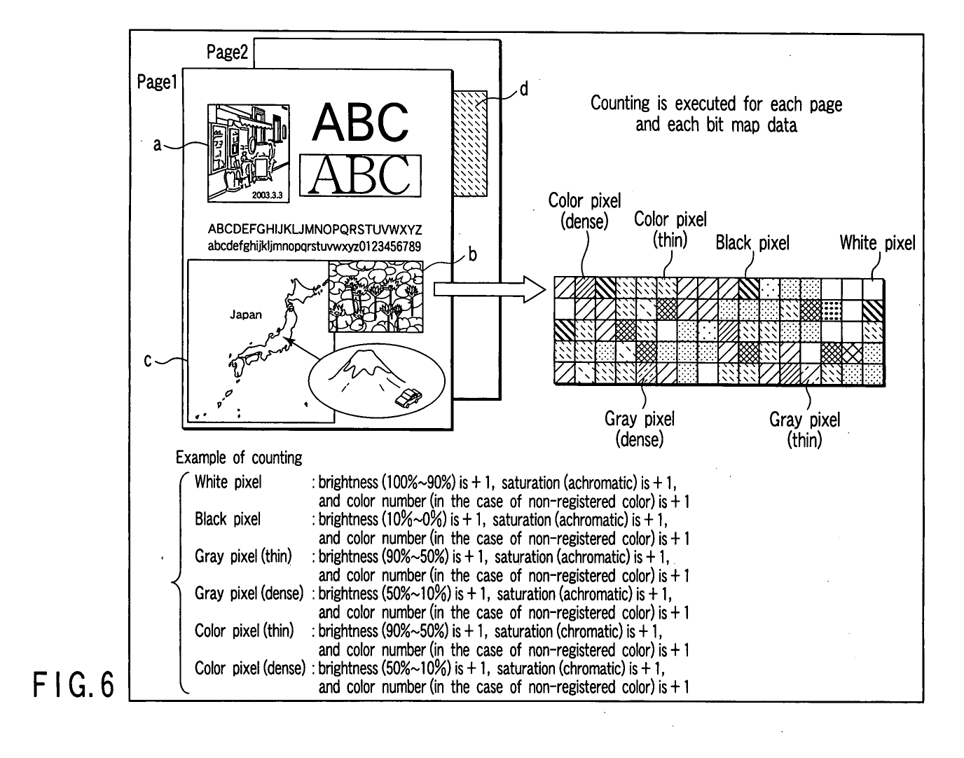

To begin with, referring to FIG. 6, a brief description is given of a process for determining the kind of bit map data using the kind of pixels that constitute a bit map and the number of pixels.

Pixels of a bit map image (bit map data) comprise achromatic black pixels, thin gray pixels, dense gray pixels, white pixels, and chromatic red, yellow, blue and green pixels. The bit map data are expressed by numerical values representing color values of pixels on PDL. When the color value is stored in an internal format within an RIP (raster image processor), a count process is executed at the same time. In the example of FIG. 6, the count process is classified into six items.

For example, the counting is performed in the following manner.

As regards the white pixel, brightness (100%-90%) is +1, saturation (achromatic) is +1, and a color number (in the case of a non-registered color) is +1.

As regards the black pixel, brightness (10%-0%) is +1, saturation (achromatic) is +1, and a color number (in the case of a non-registered color) is +1.

As regards the gray pixel (thin), brightness (90%-50%) is +1, saturation (achromatic) is +1, and a color number (in the case of a non-registered color) is +1.

As regards the gray pixel (dense), brightness (50%-10%) is +1, saturation (achromatic) is +1, and a color number (in the case of a non-registered color) is +1.

As regards the color pixel (thin), brightness (90%-50%) is +1, saturation (chromatic) is +1, and a color number (in the case of a non-registered color) is +1.

As regards the color pixel (dense), brightness (50%-10%) is +1, saturation (chromatic) is +1, and a color number (in the case of a non-registered color) is +1.

FIG. 7 shows an example of a pixel count table. The pixel count table comprises “BRIGHTNESS (L)” (10%≧L≧0, 50%≧L>10%, 90%≧L>50%, 100%≧L>90%), “ACHROMATIC”, “CHROMATIC”, “COLOR NUMBER” and “TOTAL”.

In this embodiment, the brightness (L) is classified into four. However, since there are 255 gray levels, the brightness (L) may be classified into more than four. Alternatively, a histogram may be adopted.

For example, an identifier a (object) on the first page shown in FIG. 6 has the following count numbers: brightness 10%≧L≧0 is 500, brightness 50%≧L>10% is 1800, brightness 90%≧L>50% is 100, brightness 100%≧L>90% is 800, the achromatic color is 3200, the chromatic color is 0, the color number is 80, and the TOTAL is 3200.

These count numbers are managed for each of bit map data on each page (e.g. identifiers a to d).

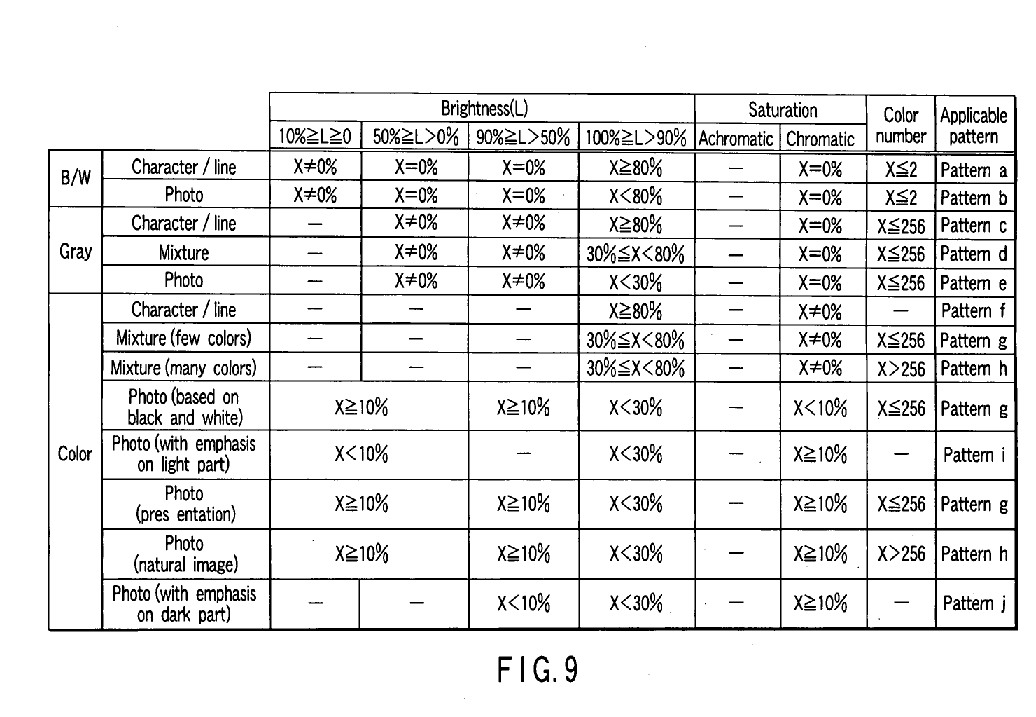

Next, based on the number of pixels that is counted for each kind of pixel by the count process, an applicable image process pattern, which is to be applied, is determined using a pixel process pattern setting table shown in FIG. 9. For example, in the case of a character/line with a black-and-white image, a pattern a is applied if X≠0% at brightness 10%≧L≧0, X=0% at brightness 90%≧L>50% is 0%, X≧80% at brightness 100%≧L>90%, X=0% as regards the chromatic color, and X≦2 as regards the color number.

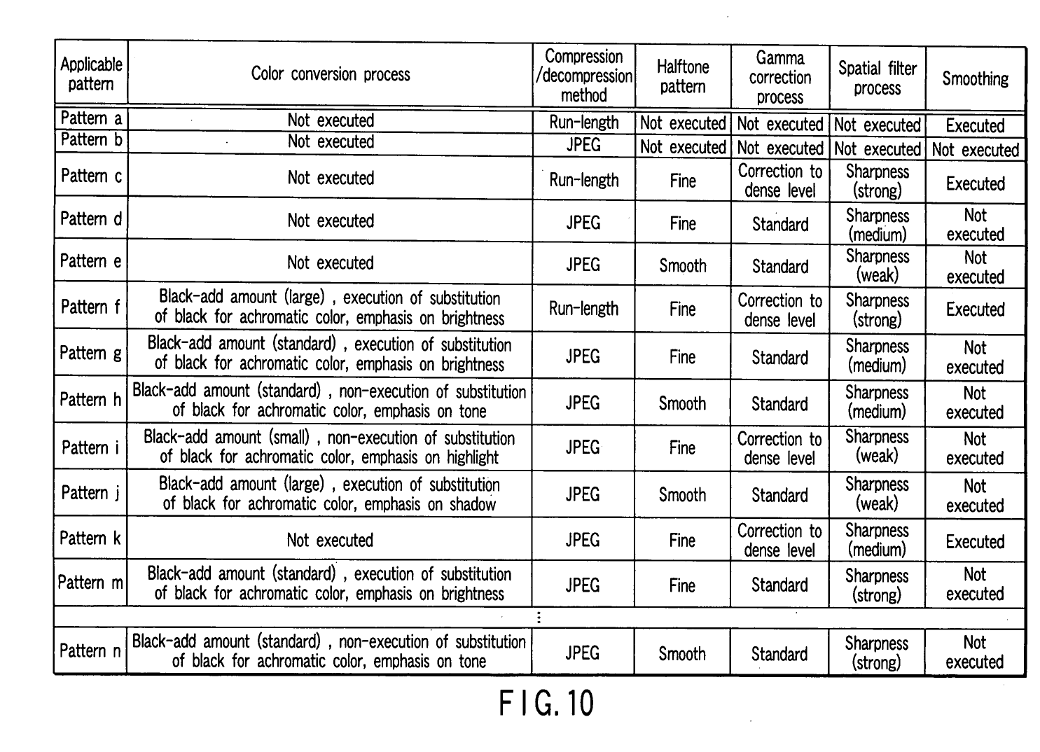

Assume that the applicable image process pattern is defined in advance on an image process combination table as shown in FIG. 10. For example, in the case of the pattern a, a color conversion process is not executed, a run-length method is used as a compression/decompression method, a halftone pattern is not executed, a gamma correction process is not executed, a spatial filter process is not executed, and smoothing is executed.

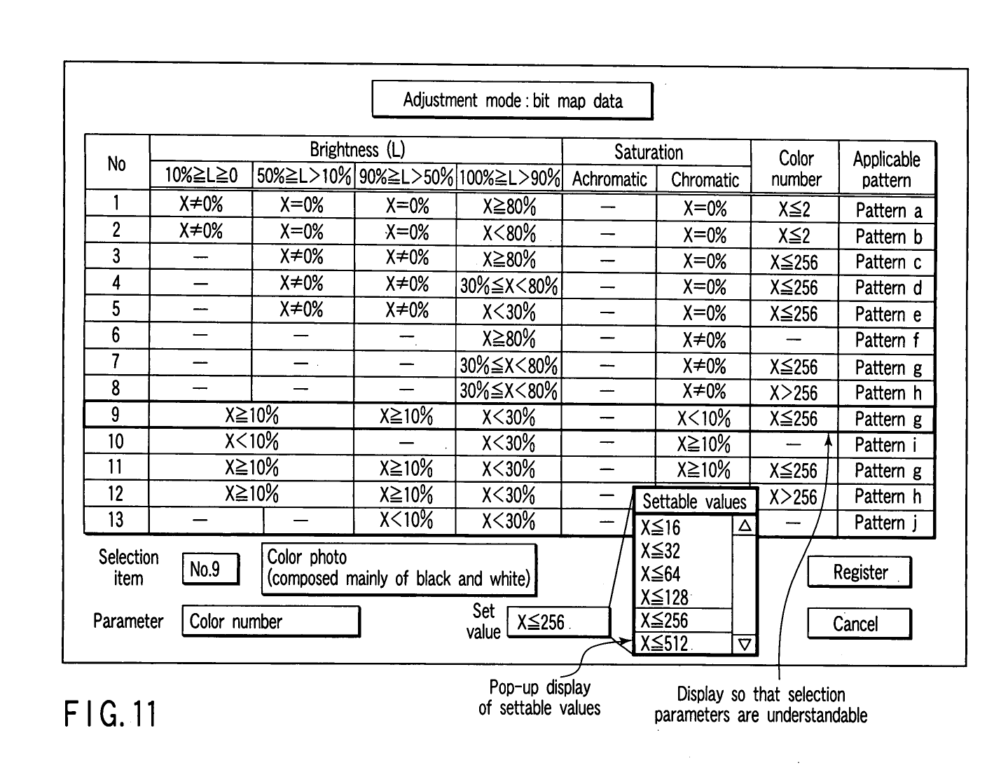

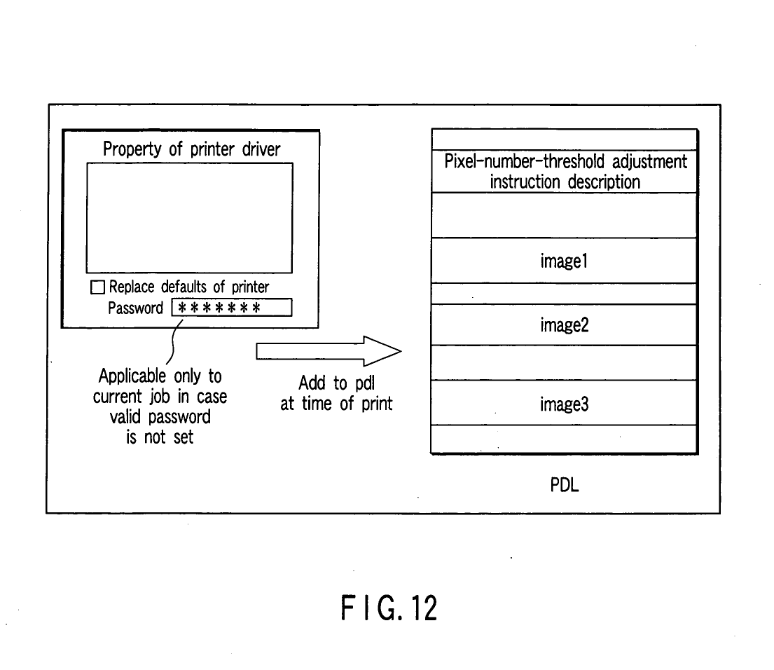

The tables shown in FIG. 9 and FIG. 10 are configured to be alterable from the PC that is connected to the MFP 10 by the user in a special mode (e.g. adjustment mode) as shown in FIG. 11. These tables are thus finely adjustable, as desired. In addition, as illustrated in FIG. 12, the tables are adjustable through, e.g. the “property” screen of the printer driver from the PC that is connected to the MFP 10. In the case of the printer driver, selection can be made between the parameter setting that is applicable only to a current print job that is about to be executed, and the parameter setting, by which the defaults of the MFP 10 are changed. Changing of the defaults of the MFP 10 is restricted by the password, etc. on the PC that is connected to the MFP 10, and only the administrator can execute such changing.

A first embodiment, to which the present invention is applied, will now be described.

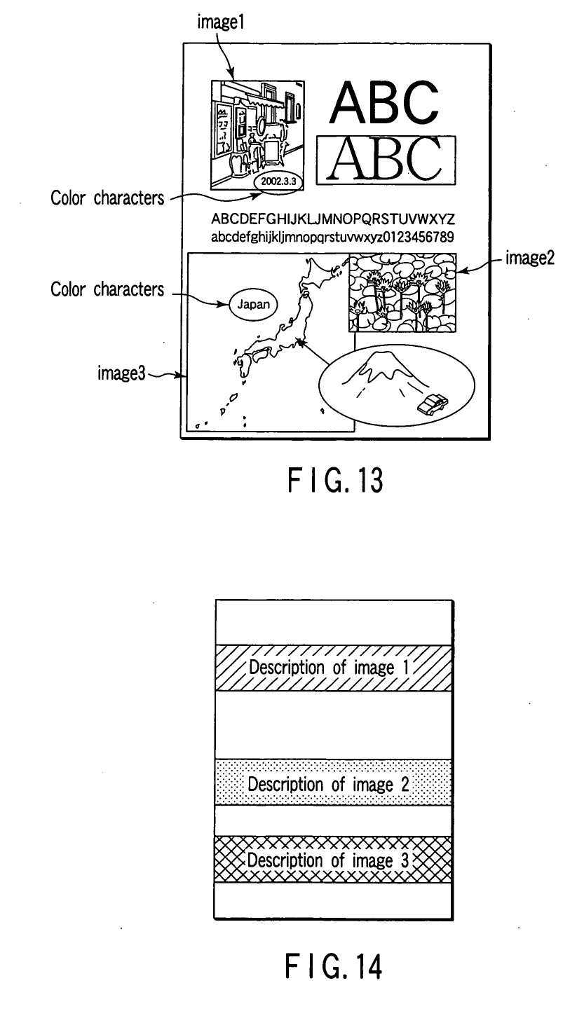

FIG. 13 shows a print original. The print original includes a black character, a color character, graphics, and bit map data. On the print original shown in FIG. 13, an image 1 (black-and-white photo with color characters), an image 2 (color photo) and an image 3 (line image with color characters) are bit map data.

If these bit map data are converted to a PDL by a printer driver of a personal computer (not shown), the converted data are described by numeral value data, etc. on a PDL file, as shown in FIG. 14. The PDL file is sent to the MFP 10.

The main CPU (RIP) 1 of the MFP 10 specifies an image drawing part on the PDL by an analysis process. Thereby, the main CPU (RIP) 1 manages the bit map data according to the internal format, and executes a pixel counting process and manages the number of pixels.

Using the counted number of pixels, a pattern that meets the conditions shown in FIG. 9 is selected, and an image process that is to be applied is determined.

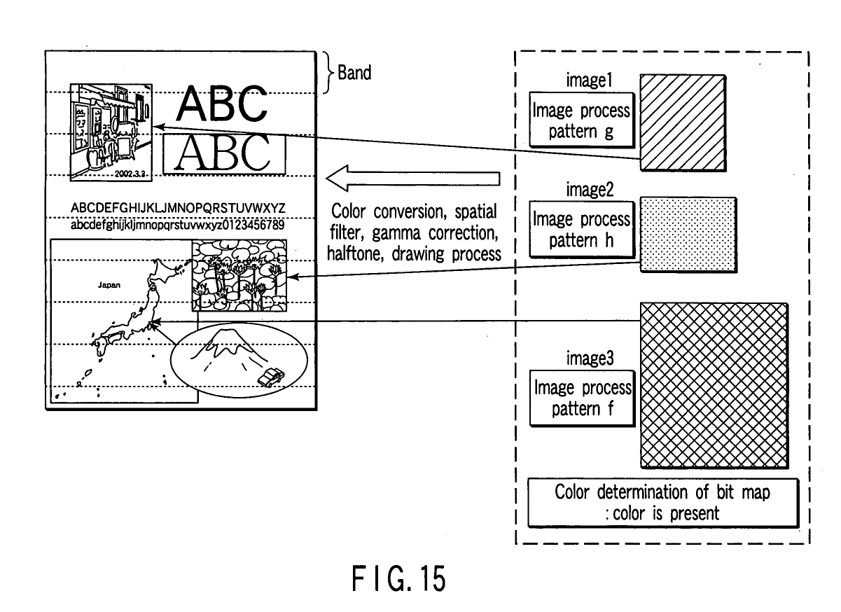

FIG. 15 shows the structure of the internal format (within a broken-line box). For example, image 1 is determined to be a gray photo with color characters (pattern g), image 2 is determined to be a color-photo natural image (pattern h), and image 3 is determined to be a B/W character/line image with color characters (pattern f). In addition, it is determined whether a plurality of bit map data within the page are all in gray or partly in color. In this example, the presence of color characters is determined because the number of color pixels is small and this is possibly indicative of the presence of a character or a line.

When the result of the determination is output to the printer unit 8, this result is used, in combination with the determination result as to whether a color part is included in text and graphics, in order to determine whether the print page is to be printed in monochrome or in color. As regards each bit map object, an applicable color conversion process, spatial filter process, gamma correction process, halftone process, drawing process and compression/decompression method are determined on the basis of the determined image process pattern and the image process combination table of FIG. 10. Thus, print data is generated. The generated print data is sent to the printer unit 8 and printed out.

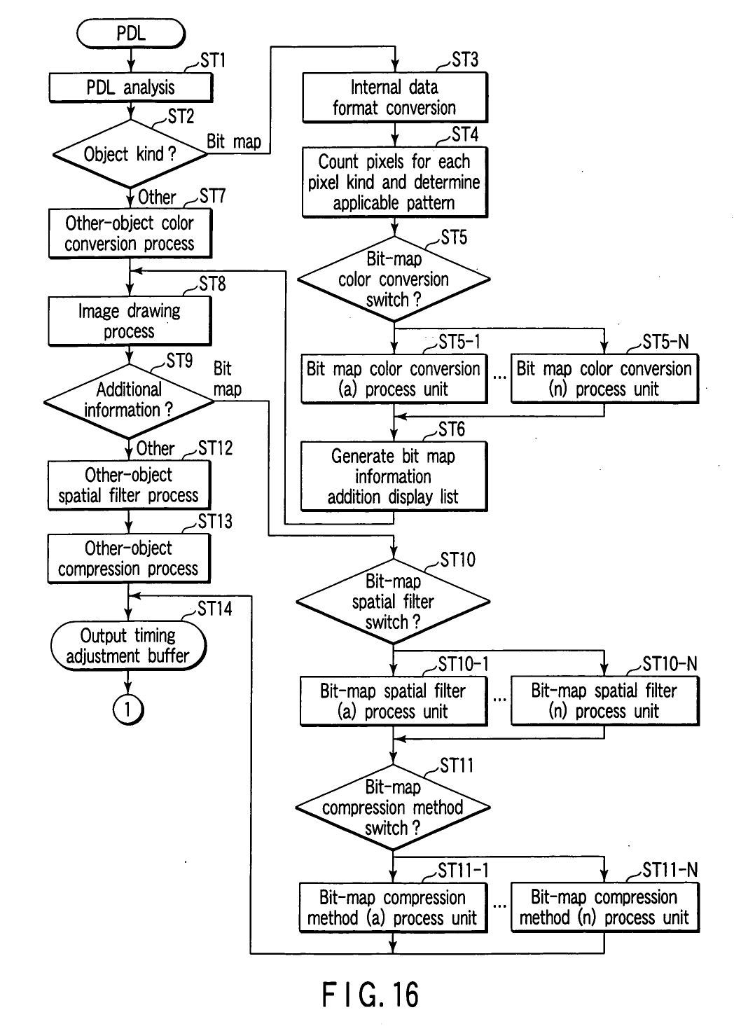

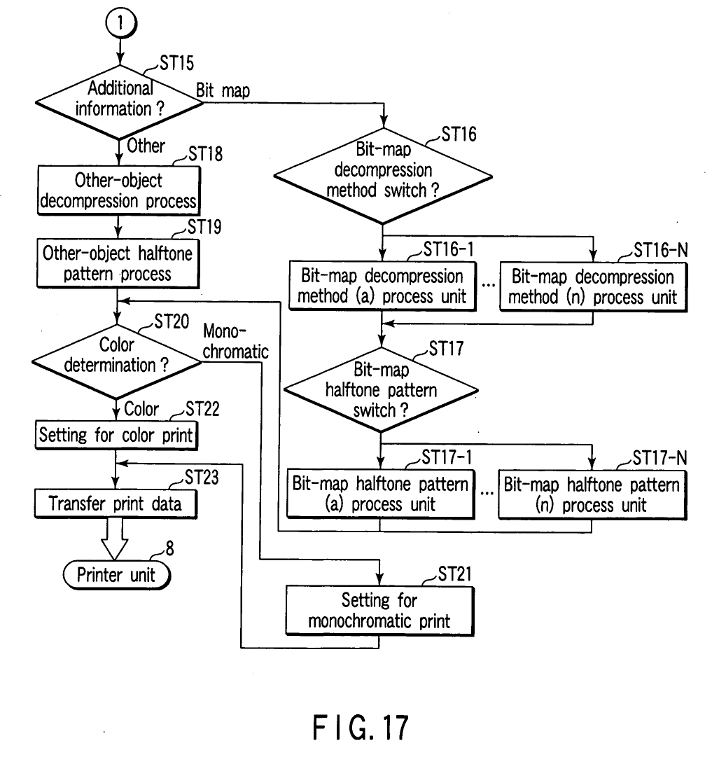

Next, the image process according to the first embodiment with the above-described structure is described with reference to flow charts of FIG. 16 and FIG. 17.

The main CPU 1 executes the following image process on the basis of a program that is prestored in the ROM 2.

To start with, the main CPU 1 analyzes a PDL that is sent via the interface 9 (ST1) and specifies the kind of the object (ST2).

If the object is specified as a bit map in step ST2, the main CPU 1 converts the bit map data to an internal data format (ST3), and counts pixels with respect to each pixel kind shown in the table of FIG. 7. Based on the count result, the main CPU 1 determines an applicable pattern from the table of FIG. 9 (ST4). In accordance with the applicable pattern determined in step ST4, the main CPU 1 switches the bit-map color conversion unit (ST5), executes the color conversion process (ST5-1 . . . ST5-N), and generates a bit map information addition display list including the determined applicable pattern (ST6).

If the kind of object is not a bit map in step ST2, the main CPU 1 executes an other-object color conversion process (ST7).

Following step ST6 or step ST7, the main CPU 1 executes an image drawing process (ST8) and confirms additional information (ST9).

If the additional information is a bit map in step ST9, the main CPU 1 switches a bit-map spatial filter process unit on the basis of the applicable pattern determined in step ST4 and the table of FIG. 10 (ST10), executes a spatial filter process (ST10-1 . . . ST10-N), switches a bit-map compression method process unit (ST11), and executes a compression process (ST11-1 . . . ST11-N).

If the additional information is not a bit map in step ST9, the main CPU 1 executes an other-object spatial filter process (ST12), and executes an other-object compression process (ST13).

Following step ST11 or step ST13, the main CPU 1 uses the RAM 3 as an output timing adjustment buffer (ST14).

When the bit map data is to be output, the main CPU 1 confirms additional information by reading out the bit map data from the RAM 3 (ST15).

If the additional information is a bit map in step ST15, the main CPU 1 switches a bit-map decompression method process unit on the basis of the applicable pattern determined in step ST4 and the table of FIG. 10 (ST16), executes a decompression process (ST16-1 . . . ST16-N), switches a bit-map halftone pattern process unit (ST17), and executes a halftone pattern process (ST17-1 . . . ST17-N).

If the additional information is not a bit map in step ST15, the main CPU 1 executes an other-object decompression process (ST18), and executes an other-object halftone pattern process (ST19).

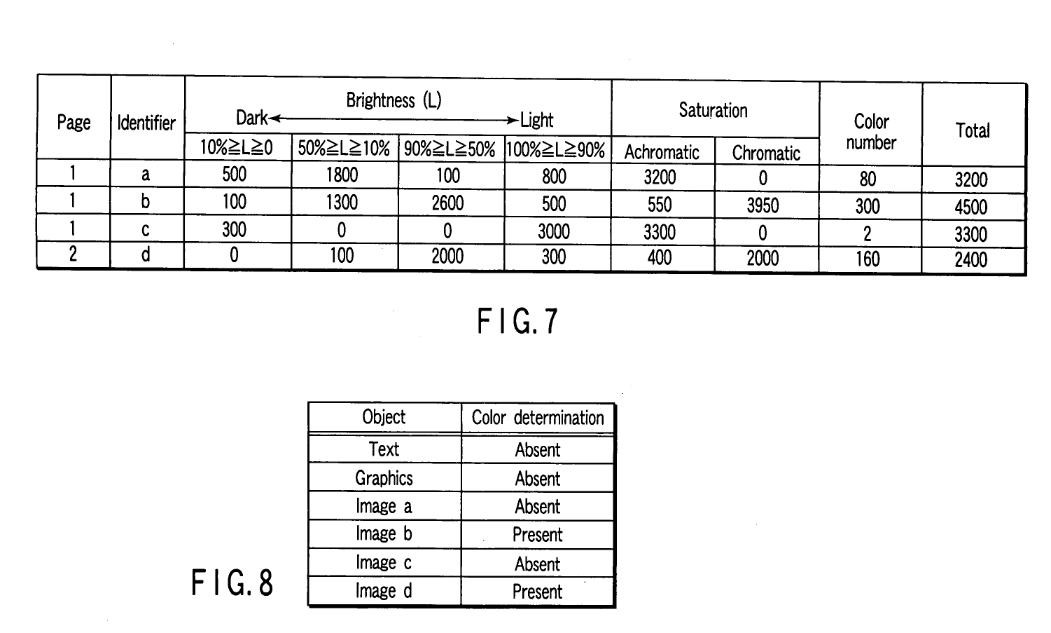

Following step ST17 or step ST19, the main CPU 1 executes color determination for the bit map data, creates a table as shown in FIG. 8, and determines whether the entire page is composed of monochromatic data (ST20).

If the determination result is monochromatic data, the main CPU 1 executes setting for monochromatic printing (ST21). If the determination result is color, the CPU 1 executes setting for color printing (ST22).

The main CPU 1 transfers the print data to the printer unit 8 (ST23).

As has been described above, according to the first embodiment, proper image processes are selected. Thereby, in the case of image 1, for instance, a gray part, which is to be printed with four-color (CMYK) toners, is printed with K toner alone. This prevents coloring due to misregistration.

In addition, as regards image 3, for instance, unsightly printing due to misregistration is prevented. In addition, by emphatically effecting gamma correction, reproducibility of thin lines is improved.

Next, a second embodiment of the invention, wherein another print original is used, is described.

A main difference between the second embodiment and the first embodiment is whether the halftone process is executed before or after the image data compression process. In the second embodiment, 8-bit data is compressed in general, and the amount of image data increases but the processibility becomes flexible. On the other hand, in the first embodiment, 1-bit data is compressed in general, and the amount of image data decreases but constraints are imposed on the data processing. In the second embodiment, the main image process can be processed by hardware, and this realizes high-speed printing. Although the reason for this will be explained later in detail, the hardware processing involves generating, as well as print image data, the data that describes a bit-map data area for instructing applicable image processes and also describes an applicable pattern. The format of this data may be a two-dimensional bit-map format, or some other optimal one for the system, such as coordinate information and a pattern number, which define a bit map area.

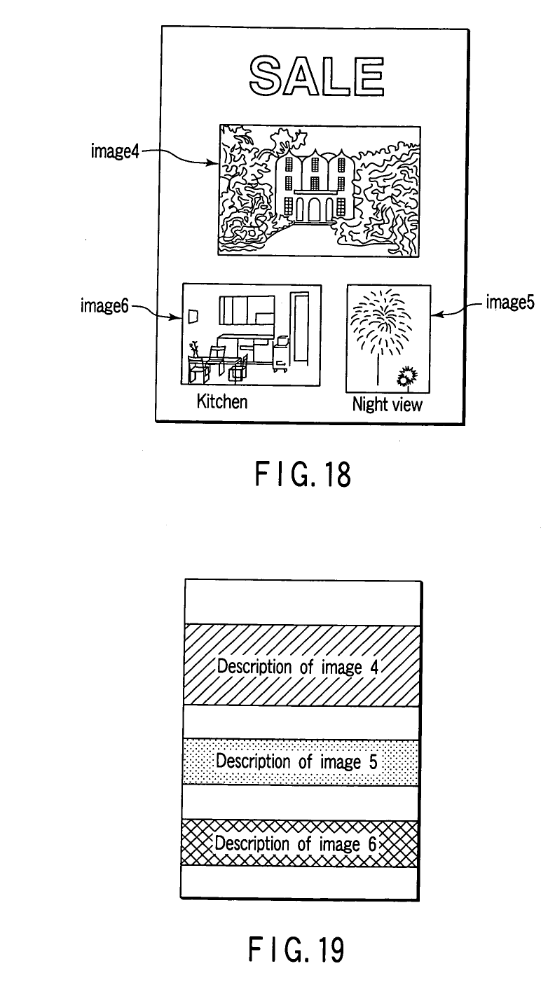

FIG. 18 shows a print original for explaining the second embodiment. The second embodiment differs from the first embodiment only as to where the image processes are to be applied, and both embodiments are common in that pixels of a bit map are classified and the counted number of pixels is used to determine the bit map classification and to select proper image processes.

If bit map data shown in FIG. 18 is converted to a PDL by a printer driver of a personal computer (not shown), the converted data is described by, e.g. numerical value data on a PDL file as shown in FIG. 19. The PDL is sent to the MFP 10.

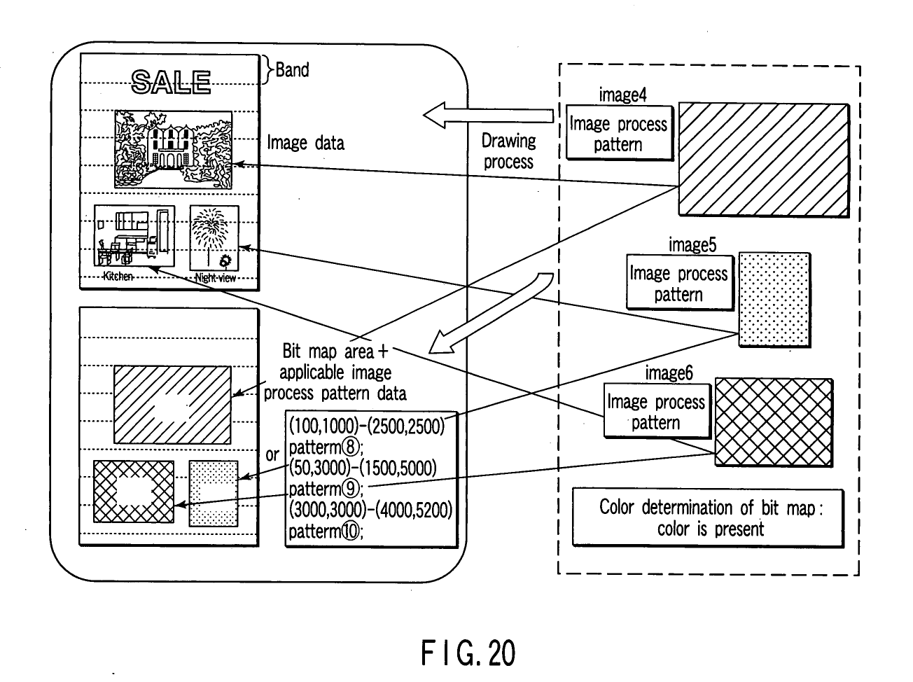

FIG. 20 shows the structure of the internal format (within a broken-line box). For example, image 4 is determined to be a color-photo natural image (pattern h), image 5 is determined to be a color photo with emphasis on shadow (pattern j), and image 6 is determined to be a color photo with emphasis on highlight (pattern i).

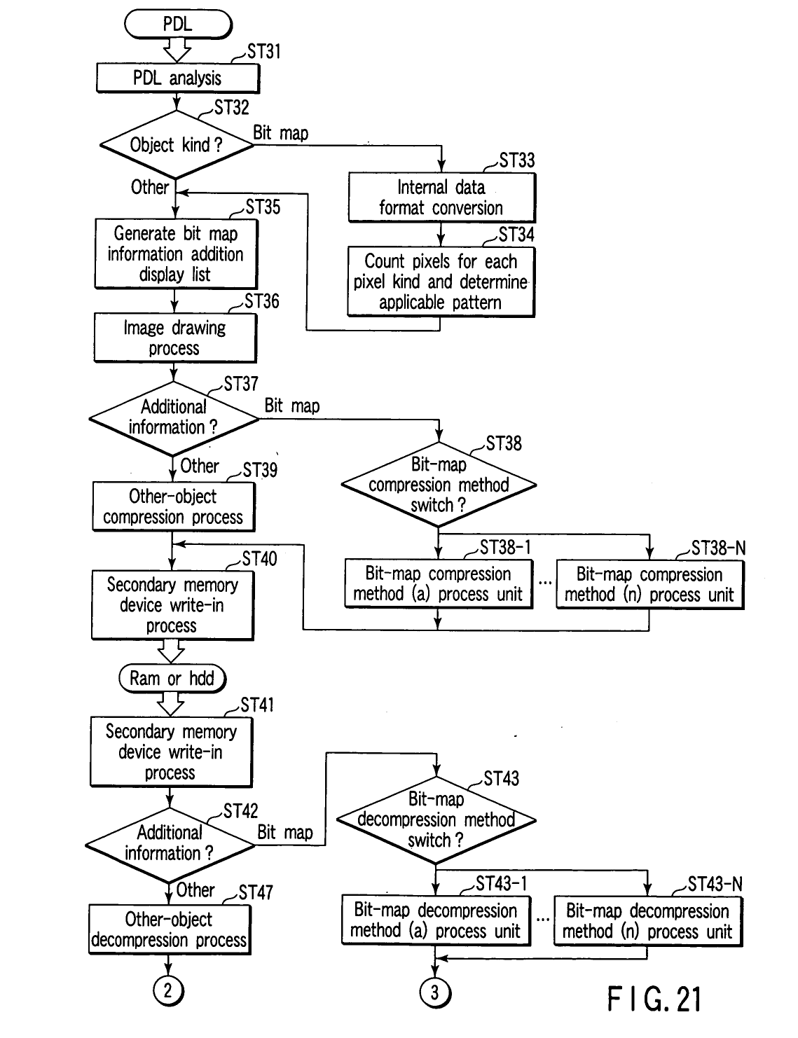

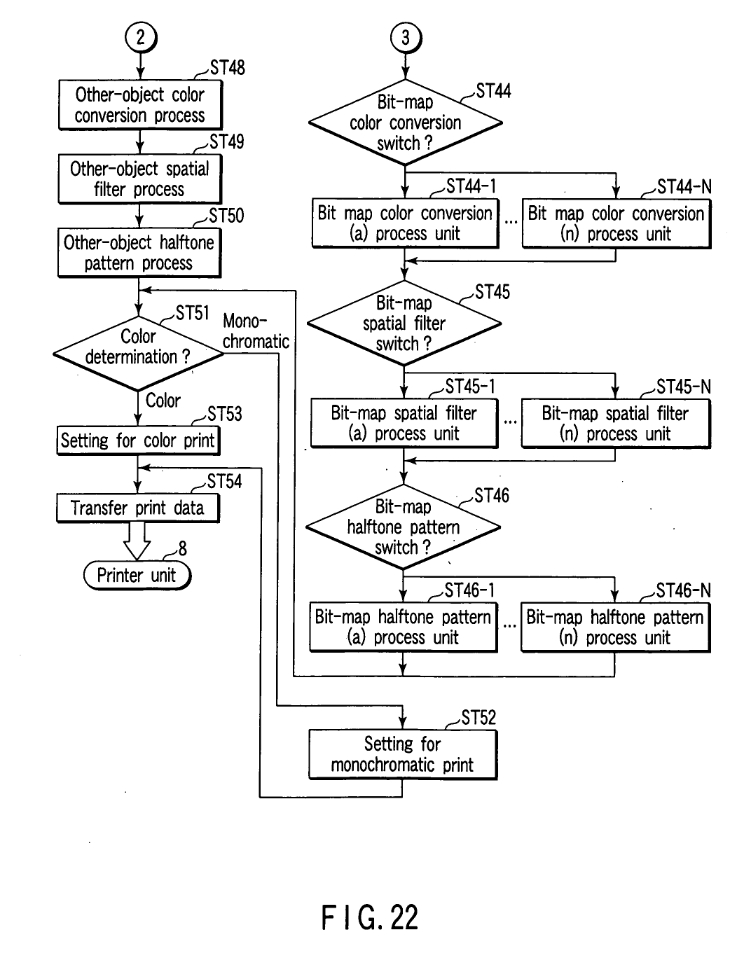

Next, the image process according to the second embodiment with the above-described structure is described with reference to flow charts of FIG. 21 and FIG. 22.

The main CPU 1 executes the following image process on the basis of a program that is prestored in the ROM 2.

To start with, the main CPU 1 analyzes a PDL that is sent via the interface 9 (ST31) and specifies the kind of the object (ST32).

If the object is specified as a bit map in step ST32, the main CPU 1 converts the bit map data to an internal data format (ST33), and counts pixels with respect to each pixel kind shown in the table of FIG. 7. Based on the count result, the main CPU 1 determines an applicable pattern from the table of FIG. 9 (ST34).

If the kind is not a bit map in step ST32, or following step ST34, the main CPU 1 generates a bit map information addition display list including the determined applicable pattern (ST35).

Subsequently, the main CPU 1 executes an image drawing process (ST36) and confirms additional information (ST37).

If the additional information is a bit map in step ST37, the main CPU 1 switches a bit-map compression method process unit on the basis of the applicable pattern determined in step ST34 and the table of FIG. 10 (ST38), executes a compression process (ST38-1 . . . ST38-N).

If the additional information is not a bit map in step ST37, the main CPU 1 executes an other-object spatial filter process (ST12), and executes an other-object compression process (ST39).

Following step ST38 or step ST39, the main CPU 1 executes write in the RAM 3 or HDD 4 that serves as a secondary memory device (ST40).

Subsequently, using the image process unit 7 that is hardware, the main CPU 1 executes the following process.

When bit map data is to be output, the main CPU 1 reads out the bit map data from RAM 3 or HDD 4 and confirms the additional information (ST41, ST42).

If the additional information is a bit map in step ST42, the main CPU 1 switches a bit-map decompression method process unit on the basis of the applicable pattern determined in step ST34 and the table of FIG. 10 (ST43) and executes a decompression process (ST43-1 . . . ST43-N); switches a bit-map color conversion process unit (ST44) and executes a color conversion process (ST44-1 . . . ST44-N); switches a bit-map spatial filter process unit (ST45) and executes a spatial filter process (ST45-1 . . . ST45-N); and switches a bit-map halftone pattern process unit (ST46) and executes a halftone pattern process (ST46-1 . . . ST46-N).

If the additional information is not a bit map in step ST42, the main CPU 1 executes an other-object decompression process (ST47), an other-object color conversion process (ST48), an other-object spatial filter process (ST49) and an other-object halftone pattern process (ST50).

Following step ST46 or step ST50, the main CPU 1 executes color determination for the bit map data, creates a table as shown in FIG. 8, and determines whether the entire page is composed of monochromatic data (ST51).

If the determination result is monochromatic data, the main CPU 1 executes setting for monochromatic printing (ST52). If the determination result is color, the CPU 1 executes setting for color printing (ST53).

The main CPU 1 transfers the print data to the printer unit 8 (ST54).

As has been described above, according to the second embodiment, proper image processes are applied. Thereby, in the case of image 5, for instance, shadow-emphasis color conversion is applied and an image with sharp black is obtained. On other hand, in the case of image 6, highlight-emphasis color conversion is applied and an image with less graininess is obtained.

According to the above-described embodiments, it is possible to execute classification of bit map data, which has been impossible in the prior art. Thereby, more appropriate image processes (color conversion, spatial filter, gamma correction, halftone pattern) can be applied to non-photo bit map data such as characters and line art other than natural images.

In addition, as regards a gray bit map, it is possible to suppress coloring on a gray part or degradation in image of a thin-line part in case misregistration occurs in CMYK printing.

Furthermore, a more appropriate algorithm can be applied to a color conversion process with a heavy processing load or to a compression/decompression process, on the basis of the characteristics of data. Therefore, the processing speed can be increased and the compressed data size can be decreased.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A printing apparatus that performs color printing, comprising:
specifying means for specifying whether print data that is to be printed by the printing apparatus includes bit map data;
classifying means for classifying pixels that constitute the bit map data, when the bit map data is specified by the specifying means;
count means for counting a number of pixels that are classified by the classifying means;
determination means for determining an image process pattern that is to be applied, on the basis of a ratio of a count number of the classified pixels that are counted by the count means; and
image process means for processing an image on an area of the bit map data, using the image process pattern that is determined by the determination means.

2. The printing apparatus according to claim 1, wherein the classifying means classifies pixels into white pixels, black pixels, thin gray pixels, dense gray pixels, thin color pixels and dense color pixels, and further classifies the pixels according to brightness, saturation and a number of colors.

3. The printing apparatus according to claim 1, wherein the image process pattern that is determined by the determination means comprises a color conversion process unit, a spatial filter process unit, a compression/decompression method process unit and a halftone pattern process unit.

4. The printing apparatus according to claim 1, wherein the image process means executes an image process using software.

5. The printing apparatus according to claim 1, wherein the image process means subjects, using software, an area of the bit map data to a color conversion process by selecting a color conversion process unit, a spatial filter process by selecting a spatial filter process unit, a compression/decompression process by selecting a compression/decompression process unit, and a halftone pattern process by selecting a halftone pattern process unit.

6. The printing apparatus according to claim 1, wherein the image process means includes discrimination means for discriminating whether the bit map data is color or not, and setting means for setting a monochromatic print or a color print in accordance with a discrimination result of the discrimination means.

7. A printing apparatus that performs color printing, comprising:
specifying means for specifying whether print data that is to be printed by the printing apparatus includes bit map data;
classifying means for classifying pixels that constitute the bit map data, when the bit map data is specified by the specifying means;
count means for counting a number of pixels that are classified by the classifying means;
determination means for determining an image process pattern that is to be applied, on the basis of a ratio of a count number of the classified pixels that are counted by the count means;
compression means for compressing the bit map data by selecting a compression method process unit that corresponds to the image process pattern determined by the determination means;
memory means for storing the compressed bit map data that is compressed by the compression means and information on the image process pattern; and
image process means for processing an image on an area of the bit map data, using the image process pattern information that is stored in the memory means.

8. The printing apparatus according to claim 7, wherein the image process means executes an image process on hardware.

9. The printing apparatus according to claim 7, wherein the image process means subjects, using hardware, an area of the bit map data to a decompression process by selecting a decompression method process unit, a color conversion process by selecting a color conversion process unit, a spatial filter process by selecting a spatial filter process unit, and a halftone pattern process by selecting a halftone pattern process unit.

10. A program for causing a printing apparatus, which performs color printing, to realize:
a specifying function for specifying whether print data that is to be printed by the printing apparatus includes bit map data;
a classifying function for classifying pixels that constitute the bit map data, when the bit map data is specified by the specifying function;
a count function for counting a number of pixels that are classified by the classifying function;
a determination function for determining an image process pattern that is to be applied, on the basis of a ratio of a count number of the classified pixels that are counted by the count function; and
an image process function for processing an image on an area of the bit map data, using the image process pattern that is determined by the determination function.

11. The program according to claim 10, wherein the image process function subjects the area of the bit map data to a color conversion process by selecting a color conversion process function, a spatial filter process by selecting a spatial filter process function, a compression/decompression process by selecting a compression/decompression process function, and a halftone pattern process by selecting a halftone pattern process function.
